(19) United States
(12) Patent Application Publication
(10) Pub. No.: US 2026/0109410 A1
(43) Pub. Date: Apr. 23, 2026

(54) TRUCK BED ASSEMBLY

(71) Applicant: NISSAN NORTH AMERICA, INC., Franklin, TN (US)

(72) Inventor: Neil Andrew FRANCUS, Plymouth, MI (US)

(21) Appl. No.: 18/920,823

(22) Filed: Oct. 18, 2024

(51) Int. Cl. B62D 33/027

(52) U.S. Cl. CPC B62D 33/0273

(57) ABSTRACT

A vehicle truck bed assembly includes a first sidewall, a second sidewall, a truck bed and a tailgate assembly movably arranged with respect to the truck bed. The tailgate assembly has a first panel with a first operating member and a second panel with a second operating member. The first and second panels are movably attached to each other. The first panel has a pair of first rollers operable by the first operating member between an extended position and a retracted position. The second panel has a pair of hinge pins operable by the second operating member between an extended position and a retracted position.

### BACKGROUND

### Technical Field

The present disclosure generally relates to a truck bed assembly. More specifically, the present disclosure relates to a truck bed assembly having a tailgate assembly capable of traveling across a roller track.

### Background Information

Currently there are a number of solutions for loading and unloading a pickup truck. Some of these solutions attempt to unload in the traditional manner by lowering the tailgate and reaching into the cargo storage area. Other solutions attempt to have a person jump into the truck bed and unload cargo.

### SUMMARY

In view of the state of the known technology, one aspect of the present disclosure is to provide a vehicle truck bed assembly comprising a first sidewall, a second sidewall, a truck bed and a tailgate assembly movably arranged with respect to the truck bed. The tailgate assembly has a first panel with a first operating member and a second panel with a second operating member. The first and second panels are movably attached to each other. The first panel has a pair of first rollers and a pair of second rollers operable by the first operating member between an extended position and a retracted position. The second panel has a pair of hinge pins operable by the second operating member between an extended position and a retracted position.

In view of the state of the known technology, one aspect of the present disclosure is to provide a tailgate assembly comprising a first panel and a second panel. The first panel has a first operating member, a pair of first rollers and a pair of second rollers operable by the first operating member between an extended position and a retracted position. The second panel has a second operating member and a pair of hinge pins operable by the second operating member between an extended position and a retracted position. The first and second panels are movably attached to each other.

### BRIEF DESCRIPTION OF THE DRAWINGS

Referring now to the attached drawings which form a part of this original disclosure:

FIG. 1 is rear elevational view of a vehicle equipped with a truck bed assembly in accordance with an illustrated embodiment;

FIG. 2 is a rear elevational view of the vehicle of FIG. 1 with the truck bed assembly in an open position that is a first operated state;

FIG. 3 is a rear perspective view of the vehicle of FIGS. 1 and 2 with the truck bed assembly in a second operated state;

FIG. 4 is a top perspective view of truck bed assembly in the second operated state;

FIG. 5 is an enlarged view of rollers of the truck bed assembly;

FIG. 6 is a top plan view of the truck bed assembly in the second operated state;

FIG. 7 is a top perspective view of a first modified truck bed assembly;

FIG. 8 is a schematic plan view of a second modified truck bed assembly;

FIG. 9 is a cross-sectional view taken along lines 9-9 of FIG. 8;

FIG. 10 is a schematic plan view of a third modified truck bed assembly; and

FIG. 11 is a cross-sectional view taken along lines 11-11 of FIG. 10.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

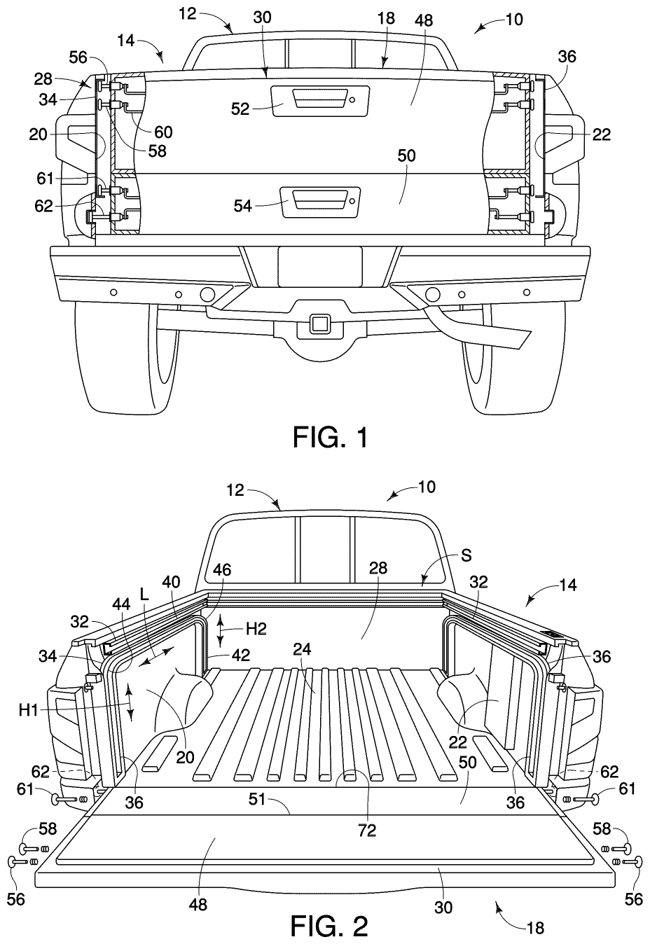

Referring initially to FIG. 1, a vehicle 10 is illustrated in accordance with an illustrated embodiment. The vehicle 10 is a pick-up truck which is a light-duty truck having an enclosed cab 12 and a truck bed assembly 14 that is configured for cargo storage. The truck bed assembly 14 includes a cargo box 16 or truck bed that defines a cargo storage space S. The truck bed assembly 14 is further equipped with the tailgate assembly 18 as will be described below.

The cargo box 16 comprises a first sidewall 20, a second sidewall 22 and a truck bed 24 (floor) connecting the first and second sidewalls 20 and 22. The cargo box 16 further includes a front wall 26 defined by a rear of the of the enclosed cab 12 and the tailgate assembly 18. As shown, the truck bed assembly 14 comprises the first and second sidewalls 20 and 22 and the truck bed 24. In the illustrated embodiment, the vehicle truck bed assembly 14 further comprises a roller track 28 provided on the first and second sidewalls 20 and 22. The tailgate assembly 18 is movably arranged with respect to the roller track 28. In particular, the tailgate assembly 18 includes a main body 30 that defines a tailgate for the cargo box 16 that encloses a rear end of the cargo box 16.

Preferably, as seen in FIG. 2, the cargo box 16 is also equipped with a standard utility track 32 or a bed rack that is part of the vehicle's 10 cargo management system. The utility track 32 is equipped with sliding cargo adjusters (not shown) that allow the user to fasten cargo along multiple positions of the cargo box 16. In the illustrated embodiment, the roller track 28 is provided in conjunction with the utility track 32. The roller track 28 is provided below the utility track 32 to enable the tailgate main body 30 to move along different positions of the cargo box 16. That is, the main body 30 of the tailgate assembly 18 is movable with respect to the roller track 28 and the utility track 32.

The roller track 28 has a first channel 34 extending along the first sidewall 20 and a second channel 36 extending along the second sidewall 22. The first and second channels 34 and 36 are identical except for their orientation and location on the cargo box 16. Therefore, only the first channel 34 will be described for brevity. As best seen in FIGS. 2 and 4, the first channel 34 extends along a first height direction H1 of the first sidewall 20, a longitudinal direction L of the first sidewall 20, and a second height direction H2 of the first sidewall 20 that is parallel to the first height direction H1.

In particular, the first channel 34 includes a rear extension 38 that extends in the first height direction H1, a longitudinal extension 40 extending along the longitudinal direction L and a front extension 42 extending in the second height direction H2. The rear extension 38 is connected to the longitudinal extension 40 by a first curved portion 44 and the front extension 42 is connected to the longitudinal extension 40 by a second curved portion 46. The first channel 34 is preferably made from a single continuous metal bar that has been flattened to have the first and second curved portions. The main body 30 is configured to move or slide continuously along the first and second channels 34 and 36 as will be described below.

The tailgate assembly 18 of the illustrated embodiment can be original equipment manufactured or can be an aftermarket product. The main body 30 of the tailgate assembly 18 is made of a high strength, light weight material suitable such as, but not limited to, high strength plastics, aluminum, and the like. In the illustrated embodiment, the main body 30 includes a first panel 48 and a second panel 50 that are movably arranged relative to each other. The first and second panels 48 and 50 are movably attached to each other so that the first and second panels 48 and 50 are pivotable with respect to each other about a hinge 51. As shown, the first panel 48 is a top panel that is located above the second panel 50 when the tailgate assembly 18 is in a rest position. In the rest position, the main body 30 encloses the rear end of the cargo box 16 as illustrated in FIG. 1. The main body 30 pivots from the rest position downward into the first operated state as shown in FIG. 2.

While the main body 30 is illustrated as being a two-piece movable member, it will be apparent to those skilled in the vehicle field from this disclosure that the main body 30 can be a single piece integrated panel or include additional panels to accommodate different channel shapes and configurations.

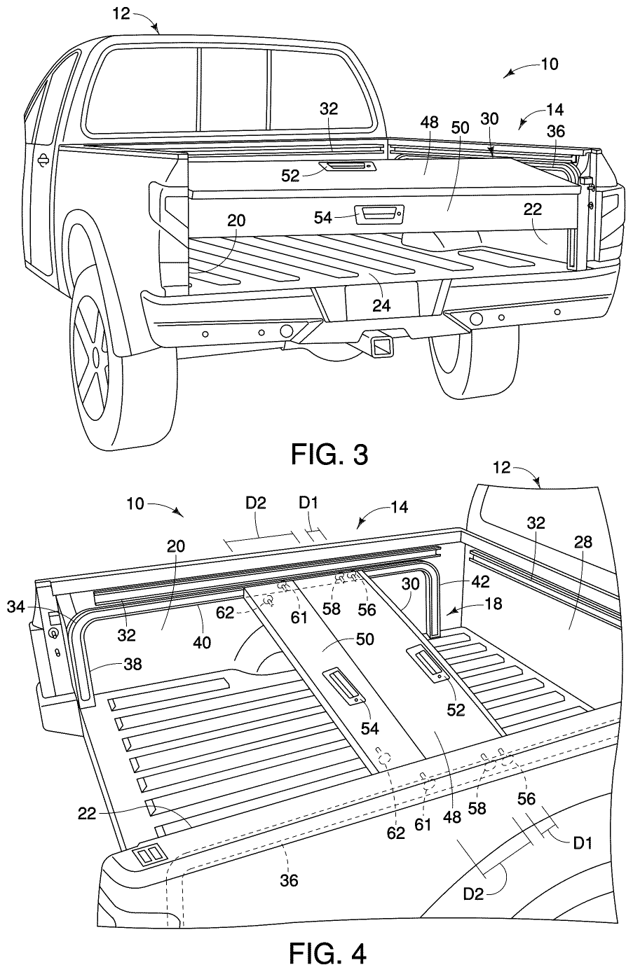

In the illustrated embodiment, the tailgate assembly 18 is operable between a first operated state and a second operated state as will be described. In the first operated state, the main body 30 forms a rearward extension of the cargo box 16 as seen in FIG. 2. In this position, the tailgate assembly 18 extends rearwardly beyond the bumper. The main body 30 moves upward from the rest position to slide within the first and second channels 34 and 36 when operated into the second operated state as shown in FIGS. 3 and 4. In the illustrated embodiment, the second operated state can include a range of positions that define the positions of the main body 30 when moving along the first and second channels 34 and 36.

In the illustrated embodiment, the main body 30 has a first operating member 52 and a second operating member 54 that operates the main body 30 between the rest position and the first and second operated states. The first panel 48 has the first operating member 52 that enables the main body 30 to move from the rest position to the first operated state. The second panel 50 has the second operating member 54 that enables the main body 30 to move from the rest position into the second operated state. In the illustrated embodiment, the first and second operating members 52 and 54 are handles or levers.

As best seen in FIG. 1, the first and second panels 48 and 50 each include a cavity defining an internal space within the first and second panels 48 and 50. The first panel 48 has a pair of first rollers 56 and a pair of second rollers 58 that are operable by the first operating member 52 between an extended position and a retracted position. The first operating member 52 is operatively connected to the first and second rollers 56 and 58 by a first linkage 62 to retract the first and second rollers 56 and 58 from the first and second channels 34 and 36. The first linkage 62 is housed in the cavity of the first panel 48. The first and second rollers 56 and 58 are engaged with the first and second channels 34 and 36 respectively when in the extended position. The first and second rollers 56 and 58 are retracted into the cavity of the first panel 48 when in the retracted position.

When in the retracted position, the first panel 48 is unlocked to enable the main body 30 to pivot into the first operated state shown in FIG. 2. In FIG. 1, the first and second rollers 56 and 58 on the right side are illustrated in the retracted position to show retraction while the first and second rollers 56 and 58 on the left side are in the extended position. However, it will be apparent to those skilled in the vehicle field from this disclosure that the first operating member 52 operates the first rollers 56 simultaneously.

The second panel 50 preferably has a pair of third rollers 61 that move along the channels 20 and 22. The second panel 50 includes a pair of hinge pins 62 operable by the second operating member 54 between an extended position and a retracted position. In the illustrated embodiment, the first rollers 56 are top rollers and the second rollers 58 are positioned between the first rollers 56 and the hinge pins 62 along a height direction of the main body 30 as seen in FIG. 1. The first and second rollers 56 and 58 are spaced with respect to each other by a first distance D1. The second rollers 58 and the hinge pins 62 are spaced with respect to each other by a second distance D2. The second distance D2 is greater than the first distance D1.

The second operating member 54 is operably connected to the hinge pins 62 by a second linkage 64 to retract the hinge pins 62 from the first and second sidewalls 20 and 22. The second linkage 64 is housed in the cavity of the second panel 50. The hinge pins 62 are engaged with the first and second sidewalls 20 and 22 respectively when in the extended position as seen with the hinge pins 62 on the left side in FIG. 1. The hinge pins 62 are retracted into the cavity of the second panel 50 when in the retracted position as seen with the hinge pins 62 on the right side of FIG. 1.

When in the retracted position, the second panel 50 is unlocked to enable the main body 30 to slide along the first and second rollers 56 and 58. In FIG. 1, the hinge pins 62 on the right side are illustrated in the retracted position to show retraction while the hinge pins 62 on the left side are in the extended position. However, it will be apparent to those skilled in the vehicle field from this disclosure that the first operating member 52 operates the hinge pins 62 simultaneously.

In the illustrated embodiment, the tailgate assembly 18 is movable along the first height direction H1, the longitudinal direction L and the second height direction H2 by the first and second rollers 56 and 58 when the hinge pins 62 are retracted. The tailgate assembly 18 is in the rest position when the hinge pins 62 are in the extended position to lock the tailgate assembly 18. The first and second operating members 52 and 54 are preferably provided with key operated locks having key holes for receiving corresponding keys (not shown). When the first and second operating members 52 and 54 are locked, they cannot be pulled outwardly to retract the first and second rollers 56 and 58 or the hinge pins 62.

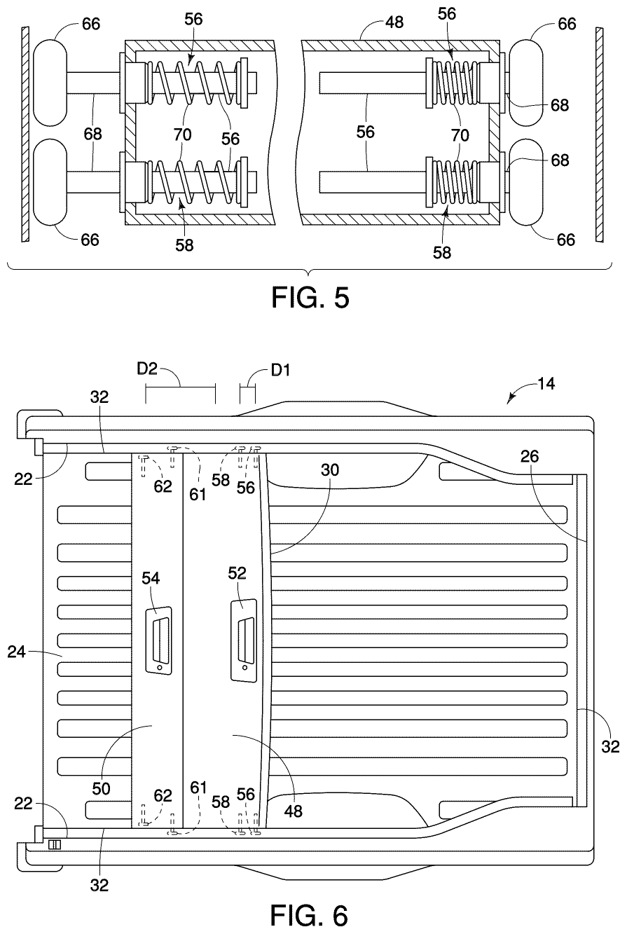

As stated, the first and second rollers 56 and 58 are movably disposed in the first and second channels 34 and 36 respectively when in the extended position to connect the tailgate assembly 18 to the first and second channels 34 and 36. The first and second rollers 56 and 58 are identical in size and shape to each other. The first and second rollers 56 and 58 each include a wheel 66 that is rotatably attached to an axle 68 that is operatively connected to the biasing member 70 at one end as best seen in FIG. 4. As seen in FIG. 5, the first and second rollers 56 and 58 are each continuously biased into the extended direction by a biasing member 70 such as a compression spring.

When the main body 30 is moved to the rest position to enclose the cargo box 16, the first and second rollers 56 and 58 are biased into the first and second channels 34 and 36 in order to latch the main body 30 closed. The tailgate assembly 18 can be moved to the open position by operating the first operating member 52 to operate the first linkage 62 into pulling the axle 68 against the compression spring 70. In this way, the first and second rollers 56 and 58 are retracted so that the main body 30 can be pivoted downwardly about the hinge pins 62 into the rest position.

Therefore, the first operating member 52 operates the first and second rollers 56 and 58 into the retracted position to enable the tailgate assembly 18 to pivot with respect to the first and second sidewalls 20 and 22 open. In other words, the first operating member 52 is operably connected to the first and second rollers 56 and 58 to retract the first and second rollers 56 and 58 from the first and second channels 34 and 36 such that the tailgate assembly 18 can pivot about a hinge that connects the main body 30 to the truck bed.

As stated, the second panel 50 includes the hinge pins 62 that movably engage the first and second sidewalls 20 and 22. The second operating member 54 operates the hinge pins 62 to enable the main body 30 to move along the first and second channels 34 and 36 via the first and second rollers 56 and 58. In particular, the main body 30 can slide along the first and second channels 34 and 36 as the first and second rollers 56 and 58 rotate when traveling. Therefore, the second operating member 54 operates the hinge pins 62 between an extended position and a retracted position to enable the tailgate assembly 18 to move within the first and second channels 34 and 36 when the pair of hinge pins 62 are in the retracted position.

The main body 30 can be moved to the rest position (closed position shown in FIG. 1) from the first operating state (open position shown in FIG. 2) by operating the first operating member 52. In this operation, the main body 30 pivots about the hinge connecting the main body 30 to the truck bed. The main body 30 can move from the rest position to the second operating state (sliding positions shown in FIGS. 3 and 4) by operating the second operating member 54 to retract the hinge pins 62. In this operation, the first and second panels 48 and 50 can be angled with respect to each other as seen in FIG. 3 when going around the curved portions of the first and second channels 34 and 36. In the second operating state, the main body 30 can move along the first and second channels 34 and 36 to modify the cargo storage area to accommodate different types of cargo.

In this way, a user can move the main body 30 between the rest position and the first and second operating states by operating the first and second operating members 52 an 54 and moving the main body 30 in a desired direction.

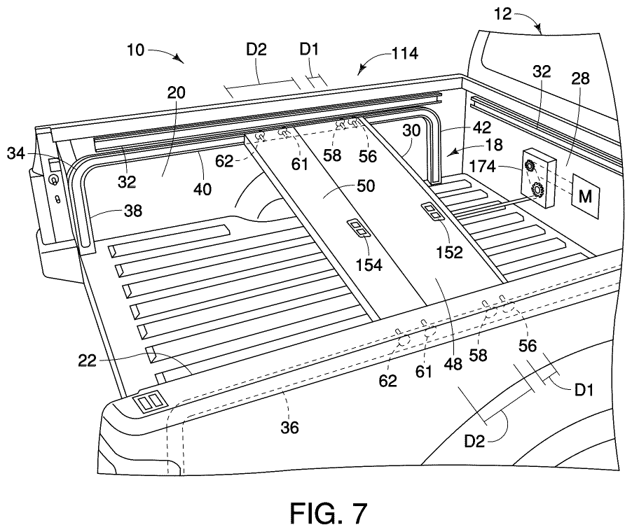

Referring now to FIG. 7, a first modified truck bed assembly 114 that can be implemented with the vehicle 10 is illustrated. The first modified truck bed assembly 114 is identical to the truck bed assembly 14 accept that it includes a gear assembly 174 that is powered by a motor M that drives the gears of the gear assembly 174 such that the first modified truck bed assembly 114 is configured for motorized or automatic movement. Due to the similarities between the first modified truck bed assembly 114 and the truck bed assembly 14, all identical components will receive the same reference numerals and all modified corresponding components will receive the same reference numerals increased by 100.

The first modified truck bed assembly 114 includes the motor M that powers the gear box that pulls a modified main body 30 via a cable. Therefore, the modified tailgate assembly 18 further comprises the gear assembly 174. The modified main body 30 includes a modified first operating member 152 and a modified second operating member 154 that are buttons. The first modified main body 30 can be implemented with the roller track 28 that is identical to the roller track 28 described above.

The modified first operating member 152 or button electronically operates a first actuator (such as a motor M that receives an electronic signal from the first operating member 52) that retracts the first and second rollers 56 and 58 from the first and second channels 34 and 36. The modified second operating member 154 or button electronically operates a second actuator (such as a motor M that receives an electronic signal from the first operating member 52) that retracts the hinge pins 62 from the first and second sidewalls 20 and 22. The second operating button can concurrently operate the motor M to send an ON signal to the motor M to drive the gear box and pull the main body 30 in the vehicle forward direction. The gear assembly 174 is operatively connected to the one of the first and second rollers 56 and 58 to pull the tailgate assembly 18 in a vehicle forward direction as the gear assembly 174 rotates.

As shown, the gear assembly 174 is provided on the front wall 26 to pull the first modified main body 30 towards the cabin 12 in the vehicle forward direction. However, it will be apparent to those skilled vehicle field from this disclosure that the first modified truck bed assembly 114 can further include another gear box and motor to pull the first modified main body 30 in the vehicle rearward direction.

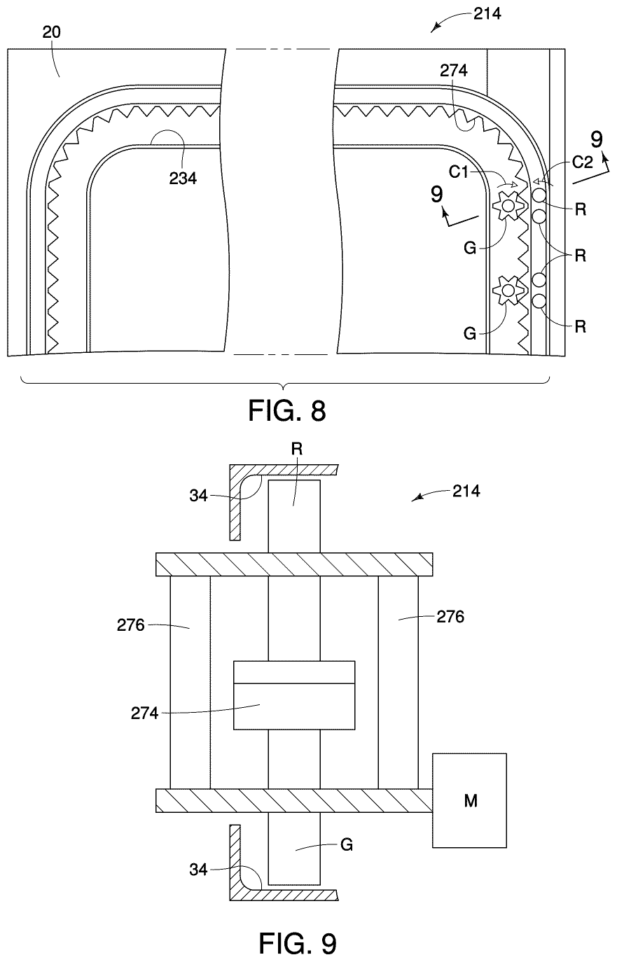

Referring now to FIGS. 8 and 9, a second modified truck bed assembly 214 is illustrated. The second modified truck bed assembly 214 includes a modified roller track 228 that is identical to the placement, shape and orientation and shape of the roller track 28. The modified roller track 228 includes modified first and second channels 234 and 236 (only the modified first channel 34 shown). The second modified truck bed assembly 214 includes a main body 30 that is identical to the modified main body 30 that includes the modified first and second operating members 52 and 54 and will receive the same numbers. Due to the similarities between the second modified truck bed assembly 214 and the truck bed assembly 14, all identical components will receive the same reference numerals and all modified corresponding components will receive the same reference numerals increased by 200.

Each of the modified first and second channels 234 and 236 includes a toothed (serrated) track 274 provided along the lengths therein (only the modified first channel 34 shown and described herein for brevity). The modified first channel 34 is further equipped with gears G. Each of the gears G interacts with rollers R of the modified main body 30 with the serrated track 274 provided therebetween. Preferably, each gear G interacts or engages with a pair of rollers of the modified main body 30 to operate the rollers R.

As shown in FIG. 8, the serrated track includes teeth or indentations that interact with corresponding teeth of the gears G. Therefore, the second modified tailgate assembly 18 further comprises pair of first and second tracks (serrated tracks) that are provided in the modified first and second channels 234 and 236 respectively. As best seen in FIG. 9, the second modified truck bed assembly 214 further includes at least one connector 276 connecting the gears G with the corresponding rollers R.

As shown in FIG. 9, the second modified truck bed assembly 214 includes a pair of connectors 276 that connects a gear G with a roller R. Although not shown, the second modified truck bed assembly 214 further includes additional connectors 276 that are identical to connect a gear G with a corresponding roller R in order to maintain a desired distance and interaction between the gears G and the rollers R. The connectors 276 are preferably spring loaded or biased to bias corresponding gears G and rollers R apart. For example the connectors 276 can be tubular members enclosing compression springs.

The second modified truck bed assembly 214 also includes a motor M that drives an axle of the gear G to drive the gear G along the serrated track 274. As the gear G travels along the serrated track 274, and the roller R travels with the gear G to drive the modified main body 30 along the modified first and second channels 234 and 236. It will be apparent to those skilled in the vehicle field from this disclosure that the motor M can drive a gear G corresponding to either one of the first and second rollers 56 and 58. It will also be apparent to those skilled in the vehicle field from this disclosure that the second modified truck bed assembly 214 can be equipped with additional motors M that drive any of the gears G to electronically operate the modified main body 30.

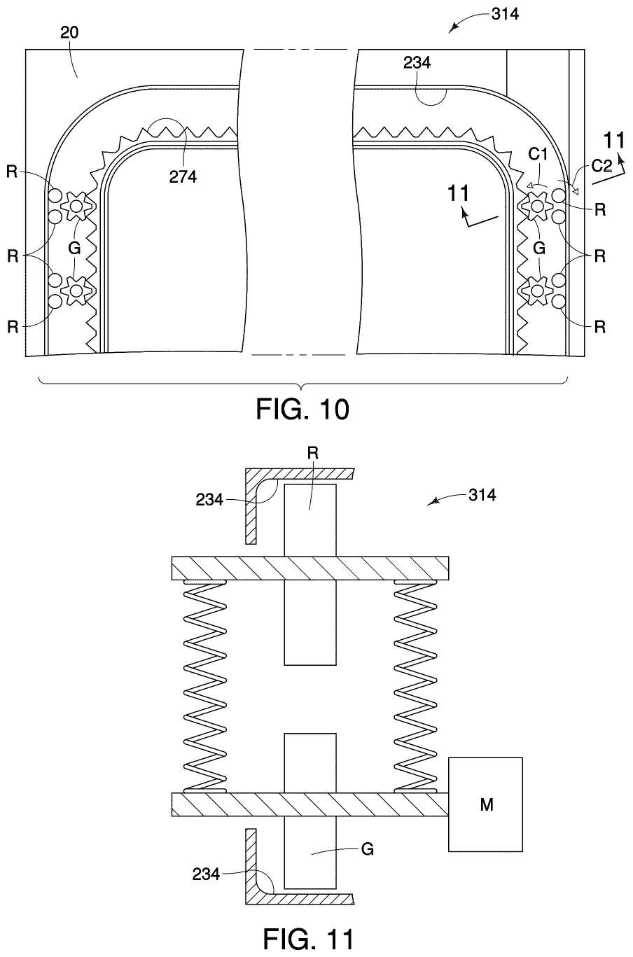

Referring now to FIGS. 9 and 10, a third modified truck bed assembly 314 is illustrated. The third modified truck bed assembly 314 includes modified first and second channels 234 and 236 having first and second serrated tracks 274 as identical to that described for the second modified truck bed assembly 214 above. The third modified truck bed assembly 314 also includes first and second serrated tracks 274 provided in the modified first and second channels 234 and 236, as described for the second modified truck bed assembly 214. The third modified truck bed assembly 314 also includes gears G that engage the rollers R of the modified main body 30 that can be identical to that of the modified main body 30 described above.

The third modified truck bed assembly 314 is basically identical to the second modified truck bed assembly 214 except that the serrated tracks 274 are not provided between the gears G and the rollers R. Here, the gears G directly engage the rollers R to drive the rollers R along the modified first and second channels 234 and 236. Due to the similarities between the third modified truck bed assembly 314 and the second modified truck bed assembly 214, all identical components will receive the same reference numerals.

The third modified truck bed assembly 314 further includes at least one motor M that drives a gear G as shown. The rollers R roll along the walls of the channels when driven by the motor M as the gear G rotates. In the third modified truck bed assembly 314, instead of connectors, the gears G and corresponding rollers R are connected by biasing members. For example, the biasing members are springs that bias the gear G and rollers R apart so that the rollers are pushed along the walls of the first and second channels 234 and 236 in order to travel along the first and second channels 234 and 236 while the motor M is driving the gear G.

In understanding the scope of the present invention, the term “comprising” and its derivatives, as used herein, are intended to be open ended terms that specify the presence of the stated features, elements, components and/or groups, but do not exclude the presence of other unstated features, elements, components and/or groups. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the truck bed assembly. Accordingly, these terms, as utilized to describe the present invention should be interpreted relative to a vehicle equipped with the truck bed assembly.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle truck bed assembly comprising:
a first sidewall;
a second sidewall;
a truck bed connecting the first and second sidewalls;
a roller track having a first channel extending along the first sidewall and a second channel extending along the second sidewall; and
a tailgate assembly movably arranged with respect to the roller track, the tailgate assembly having
a main body having a first operating member and a second operating member,
a pair of first rollers movably disposed in the first and second channels respectively when in an extended position to connect the tailgate assembly to the first and second channels, the first operating member operating the first rollers into a retracted position to enable the tailgate assembly to pivot with respect to the first and second sidewalls.

2. The vehicle truck bed assembly according to claim 1, wherein
the tailgate assembly further includes a pair of hinge pins movably engaging the first and second sidewalls, the second operating member operating the pair of hinge pins to enable the main body to move along the first and second channels along the first rollers.

3. The vehicle truck bed assembly according to claim 2, wherein
the main body includes a first panel and a second panel that are movably arranged relative to each other,
the first panel having the first rollers,
the second panel having the hinge pins.

4. The vehicle truck bed assembly according to claim 3, wherein
the hinge pins are engaged with the first and second sidewalls when in the extended position,
the second operating member operating the hinge pins between an extended position and a retracted position to enable the tailgate assembly to move within the first and second channels when the pair of hinge pins are in the retracted position.

5. The vehicle truck bed assembly according to claim 4, wherein
the first operating member is operably connected to the first rollers to retract the first rollers from the first and second channels such that the tailgate assembly can pivot about the hinge pins.

6. The vehicle truck bed assembly according to claim 2, further comprising
a pair of second rollers, the first rollers being top rollers and the second rollers being positioned between the first rollers and the hinge pins along a height direction of the main body.

7. The vehicle truck bed assembly according to claim 6, wherein
the first and second rollers are spaced with respect to each other by a first distance, the second rollers and the hinge pins are spaced with respect to each other by a second distance, the second distance being greater than the first distance.

8. The vehicle truck bed assembly according to claim 2, wherein
the first and second channels extend along a first height direction of the first and second sidewalls, a longitudinal direction of the first and second sidewalls, and a second height direction of the first and second sidewalls that is parallel to the first height direction.

9. The vehicle truck bed assembly according to claim 8, wherein
the tailgate assembly is movable along the first height direction, the longitudinal direction and the second height direction by the first and second rollers when the hinge pins are retracted.

10. The vehicle truck bed assembly according to claim 3, wherein
the first operating member is a first handle that is operatively connected to the first rollers by a first linkage to retract the first rollers from the first and second channels.

11. The vehicle truck bed assembly according to claim 10, wherein
the second operating member is a second handle that is operably connected to the hinge pins by a second linkage to retract the hinge pins from the first and second sidewalls.

12. The vehicle truck bed assembly according to claim 3, wherein
the first and second panels are pivotable with respect to each other about a hinge.

13. The vehicle truck bed assembly according to claim 12, wherein
the first panel is a top panel that is located above the second panel when the tailgate assembly is in a rest position in which the hinge pins are in the extended position to lock the tailgate assembly.

14. The vehicle truck bed assembly according to claim 2, wherein
the first operating member electronically operates a first actuator that retracts the first rollers from the first and second channels.

15. The vehicle truck bed assembly according to claim 14, wherein
the second operating member electronically operates a second actuator that retracts the hinge pins from the first and second sidewalls.

16. The vehicle truck bed assembly according to claim 15, further comprising
a gear assembly operatively connected to the one of the first rollers to pull the tailgate assembly in a vehicle forward direction as the gear assembly rotates.

17. A tailgate assembly comprising:
a first panel with a first operating member, the first panel having a pair of first rollers operable by the first operating member between an extended position and a retracted position; and
a second panel with a second operating member, the second panel having a pair of hinge pins operable by the second operating member between an extended position and a retracted position, the first and second panels being movably attached to each other.

18. The tailgate assembly according to claim 17, further comprising
a pair of second rollers,
the first and second rollers being spaced with respect to each other by a first distance, the second rollers and the hinge pins being spaced with respect to each other by a second distance, the second distance being greater than the first distance.
